(19) United States
(12) Patent Application Publication
(10) Pub. No.: US 2025/0321974 A1
(43) Pub. Date: Oct. 16, 2025

(54) SYSTEMS AND METHODS FOR CENTRALIZED DATA MANAGEMENT

(71) Applicant: William E. Dyess, Silver Spring, MD (US)

(72) Inventor: William E. Dyess, Silver Spring, MD (US)

(21) Appl. No.: 19/018,697

(22) Filed: Jan. 13, 2025

Related U.S. Application Data
(60) Provisional application No. 63/620,421, filed on Jan. 12, 2024.

(51) Int. Cl. G06F 16/25; G06F 9/445

(52) U.S. Cl. CPC G06F 16/252; G06F 9/44526

(57) ABSTRACT

A system for centralized data management includes a processor and a memory including instructions, which when executed by the processor, cause the system to: access data in a first application using a first plug-in, the data associated with a global identifier; communicate an update of the accessed data to a server using the first plug-in, the update including the global identifier; update a state of the data at the server with the accessed data based on the global identifier; receive a request from a second application using the second plug-in to update a shape including the data; determine a current state of the data in the shape; synchronize the state of the data in the server and the second application based on the global identifier; and update the shape in the second application based on the synchronized data.

### CROSS-REFERENCE TO RELATED APPLICATION AND CLAIM OF PRIORITY

This application claims the benefit of, and priority to, U.S. Provisional Patent Application No. 63/620,421, filed on Jan. 12, 2024, the entire contents of which are hereby incorporated herein by reference.

### TECHNICAL FIELD

The present application relates to systems and methods for centralized data management, and, more specifically, to a system and method for managing data associated with user documentation including presentation and spreadsheet data.

### BACKGROUND

Centralized data management creates a single authoritative source of company data, thereby improving company data integrity, consistency, and quality control. Modern centralized data management systems often face challenges related to context, data ownership, and user permissions. For example, updates within an original presentation document are often difficult to synchronize with various secondary documents. Moreover, version control related to such updates is generally difficult to track without significant overhead.

Accordingly, there is a need for a new centralized data management system for managing data associated with user documentation.

### SUMMARY

In accordance with aspects of the present disclosure, a system for centralized data management includes a processor and a memory including instructions, which when executed by the processor, cause the system to: access data in a first application using a first plug-in, the data associated with a global identifier; communicate an update of the accessed data to a server using the first plug-in, the update including the global identifier; update a state of the data at the server with the accessed data based on the global identifier; receive a request from a second application using the second plug-in to update a shape including the data; determine a current state of the data in the shape; synchronize the state of the data in the server and the second application based on the global identifier; and update the shape in the second application based on the synchronized data. Updating the state of the data at the server triggers an event listener in a second plug-in.

In an aspect of the present disclosure, the first application may be a data management application.

In another aspect of the present disclosure, the second application may be a canvas-based design medium.

In yet another aspect of the present disclosure, the shape may be located in a slide of the canvas-based design medium.

In a further aspect of the present disclosure, the shape may be a text box, an image, a video, a table, a geometric shape, and/or a freeform shape.

In yet a further aspect of the present disclosure, updating the shape may include updating an alphanumerical value, a shape, a size, a color, and/or coordinates of the shape in a fixed canvas.

In an aspect of the present disclosure, the shape may be immutable within the second application.

In another aspect of the present disclosure, multiple shapes may be configured to be grouped together as an immutable component.

In yet another aspect of the present disclosure, the first plug-in and the second plug-in may be configured to render a domain-specific language for communicating with the server to synchronize the data. Determining the current state of the data in the shape may include determining a latest version of the data stored in a database hosted by the server.

In a further aspect of the present disclosure, the first plug-in and the second plug-in may be configured to track individual events related to changes to the data within the first application and the second application respectively. The tracked individual events may be accessible on at least one of a web application of the system or a report exported by the web application.

In accordance with aspects of the present disclosure, a method for centralized data management includes: accessing data in a first application using a first plug-in, the data associated with a global identifier; communicating an update of the accessed data to a server using the first plug-in, the update including the global identifier; updating a state of the data at the server with the accessed data based on the global identifier; receiving a request from a second application using the second plug-in to update a shape including the data; determining a current state of the data in the shape; synchronizing the state of the data in the server and the second application based on the global identifier; and updating the shape in the second application based on the synchronized data. Updating the state of the data at the server triggers an event listener in a second plug-in.

In accordance with aspects of the present disclosure, a non-transitory computer readable storage medium may include instructions that, when executed by a computer, cause the computer to perform a method for centralized data management, the method including: accessing data in a first application using a first plug-in, the data associated with a global identifier; communicating an update of the accessed data to a server using the first plug-in, the update including the global identifier; updating a state of the data at the server with the accessed data based on the global identifier; receiving a request from a second application using the second plug-in to update a shape including the data; determining a current state of the data in the shape; synchronizing the state of the data in the server and the second application based on the global identifier; and updating the shape in the second application based on the synchronized data. Updating the state of the data at the server triggers an event listener in a second plug-in.

### BRIEF DESCRIPTION OF THE DRAWINGS

A better understanding of the features and advantages of the disclosed technology will be obtained by reference to the following detailed description that sets forth illustrative embodiments, in which the principles of the technology are utilized, and the accompanying drawings of which:

FIG. 1 is a diagram of an example of a system for centralized data management, in accordance with aspects of the present disclosure;

FIG. 2 is a diagram of an example of components in a system, device, or server, in accordance with aspects of the present disclosure;

FIG. 3 is an illustration of a workflow of the system of FIG. 1, in accordance with aspects of the present disclosure;

FIGS. 4, 5A, and 5B are illustrations of exemplary screens within a web application of the system of FIG. 1, in accordance with aspects of the present disclosure; and

FIGS. 6A-6C are illustrations of exemplary screens within a plug-in of the system of FIG. 1, in accordance with aspects of the present disclosure; and

FIG. 7 is an exemplary method of using a system for centralized data management, in accordance with aspects of the present disclosure.

### DETAILED DESCRIPTION

The present application relates to systems and methods for centralized data management.

A system for centralized data management may manage and/or synchronize data between documentation tools. For example, the system may manage and/or synchronize data from spreadsheet cells to shapes within a slideshow presentation. To do so, the system may correlate a unique identifier with the shape(s) and/or use plug-in-based verification to verify a status of individual data as related to a centralized source of truth (e.g., a centralized database). The unique identifiers may group individual data in a human readable format.

The system provides a benefit over traditional centralized data management systems by creating immutable shape identifiers with version control with cross-application integration, so that data may be managed between a variety of different applications. The system is capable of maintaining seamless communication between various documentation applications, which was previously difficult due to the high complexities of version control for granular changes at the shape level (e.g., tracking and merging changes, and the large overhead for maintaining a detailed history of such changes), scalability issues, user access complexities, workflow challenges (e.g., maintaining links between cells, server records, and slide shapes), and conflict resolution issues for simultaneous edits. The system overcomes these challenges through an improved centralized data management system. For example, as discussed further below, the system includes robust plug-ins, which communicate globally unique identifiers to ensure the integrity of immutable shape identifiers for adaptive updates that avoid collisions, based on a series of mechanisms. Moreover, the system provides visual tools to compare versions of shapes, cells, and/or entire presentations. In addition, the system uses end-to-end encryption for data exchanged between applications with role-based access controls to restrict modifications to authorized users. These and additional benefits are discussed further below.

The system generally enables storage, retrieval, and synchronizing of defined figures, which permit a user to view each individual instance and/or appearance of the defined figures (e.g., data within a shape). For example, a user may view each shape instance within a presentation. A web-based application may enable a user to update each instance of a figure across every presentation, based on a version stored centrally and/or viewable on a web application. The web application may enable a central view of all data figures and/or an option to approve any syncs from the web client across presentations. For example, the web application may display data for each instance of a figure and/or dataset, including: a synchronization status; a last date of synchronization; a user who performed a synchronization request; a list of synchronized versions for each user; data within each synchronized version; user responsibility for changing and/or synchronizing or additional action to be taken.

For the purpose of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Various alterations, rearrangements, substitutions, and modifications of the features illustrated herein, and any additional applications of the principles of the present disclosure as illustrated herein, which would occur to one skilled in the relevant art and having possession of this disclosure, are to be considered within the scope of the present disclosure.

As used herein, “data” refers to any form of information, values, content, or representational constructs that can be processed, transmitted, stored, and/or displayed by a computing system. Data may include numerical values, textual content, visual representations, graphical elements, metadata, or any other type of structured or unstructured information. For example, data may encompass the contents of a spreadsheet cell, including (e.g., timestamp of change, user details, or cell address) linked to a global identifier and updated to a central server. In another example, data may include information retrieved from a central server, which is linked to a shape in a presentation application, such as the contents of the spreadsheet cell and/or additional numerical, textual, and/or graphical parameters (e.g., xy coordinates related to shape, size, and/or position in a slide) related to the shape for synchronization.

As used herein, the term “synchronize” may generally refer to an ongoing process of synchronization using a central database, which causes a set of data and/or files to update and remain identical in one or more locations. In doing so, the locations may maintain consistent data to avoid conflicts. The system disclosed herein may use file synchronization in various locations, including one or more devices, applications, servers. etc. The synchronization process may implement version control, providing a synchronization solution for data and/or files that may be modified by multiple users in different locations. Therefore, the system may be configured to maintain separate file versions at different locations, which can each be updated and/or synchronized based on user input.

As used herein, a “shape” may generally refer to a geometric and/or freeform figure or object that can be created, manipulated, and/or displayed within a computer-based software application, such as a presentation program. A shape may include a text box, an image, a video, a flowchart, a table, a button, a comment, a basic geometric shape (e.g., lines, rectangles, squares, circles, ellipses, triangles, polygons, and/or stars), a freeform shapes (e.g., an irregular or user-defined contour and/or path that may be drawn using tools within an application), a complex shape (e.g., a combination and/or grouping of shapes to form compound figures or designs), and/or a decorative or illustrative shape (e.g., figures that incorporate embellishments and/or patterns for aesthetic or communicative purposes).

As used here, a “plug-in” may generally refer a set of instructions, such as a modular software component and/or program, designed to interact with a host application to extend functionality and/or enable specific operations. The plug-in can operate within the environment of the host application and/or leverage interfaces to perform tasks that may include data monitoring, processing, communication, and/or synchronization with external systems or other applications. For example, a plug-in may be integrated with a spreadsheet application to monitor data in specified cells, detect changes in cell values, and identify their association with globally unique identifiers. The plug-in may communicate the updated values, along with the associated identifiers, to a central server via a defined protocol, ensuring synchronization across systems. In another example, a plug-in within a presentation application may identify shapes associated with global identifiers. Upon detecting updates at the central server corresponding to the global identifiers, the plug-in retrieves the updated values and applies changes to the linked shapes in the presentation. Updated values may include changes in the values from the spreadsheet application (e.g., alphanumeric values) and/or design-related changes of the shape or slide in the presentation application (e.g., numerical, textual, and/or graphical parameters such as xy coordinates related to shape, size, and/or position in a slide).

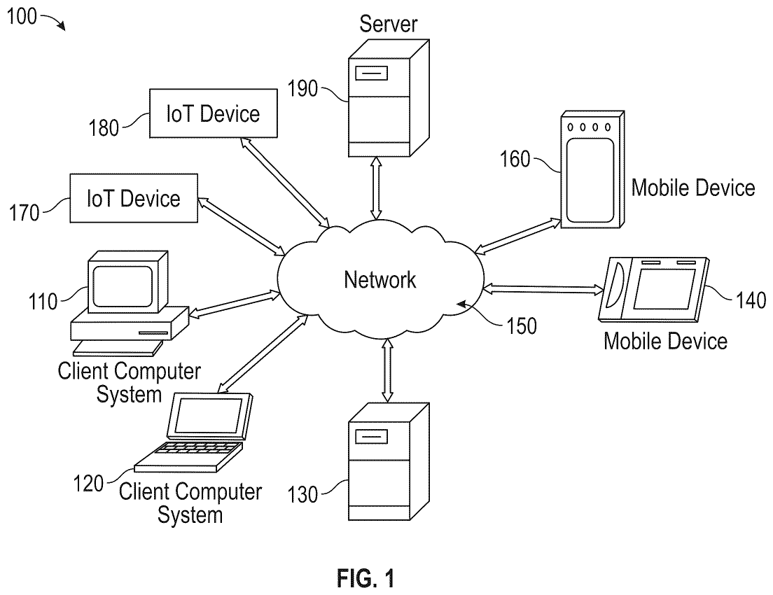

Referring to FIG. 1, a system 100 for centralized data management is shown in accordance with aspects of the present disclosure. The system 100 includes one or more client computer systems 110, 120, a cloud system 130, a network 150, one or more mobile devices 140, 160, one or more IOT devices 170, 180, and a server 190. The client computer systems 110, 120 communicate with the server 190 across the network 150. It is contemplated that multiple servers 190 may be used in a distributed architecture and/or in a cloud.

The server 190 provides a repository of instrumented OSS components that may be accessed by developers and/or by build automation software at the client computer systems 110, 120 to build applications. The term “application” may include a computer program designed to perform particular functions, tasks, or activities. An application may be software or firmware and may be deployed on any platform, such as on the client computer systems 110, 120, on mobile devices 140, 160, and/or on IOT devices 170, 180, among others, such as, but not limited to, consumer electronics, networking devices, enterprise systems, etc. An application may refer to, for example, software running locally or remotely, as a standalone program or in a web browser, or other software which would be understood by one skilled in the art to be an application. In embodiments, an application may run on a server and/or on a user device. Two client computer systems 110, 120 are illustrated as examples, but more than two client computer systems may exist in system 100.

The network 150 may be wired or wireless, and can utilize technologies such as Wi-Fi, Ethernet, Internet Protocol, 4G, and/or 5G, or other communication technologies. The network 150 may include, for example, but is not limited to, a cellular network, residential broadband, satellite communications, private network, the Internet, local area network, wide area network, storage area network, campus area network, personal area network, or metropolitan area network.

The illustrated networked environment of system 100 is merely exemplary. In embodiments, other systems, servers, and/or devices not illustrated in FIG. 1 may be included. In embodiments, one or more of the illustrated components may be omitted. Such and other embodiments are contemplated to be within the scope of the present disclosure.

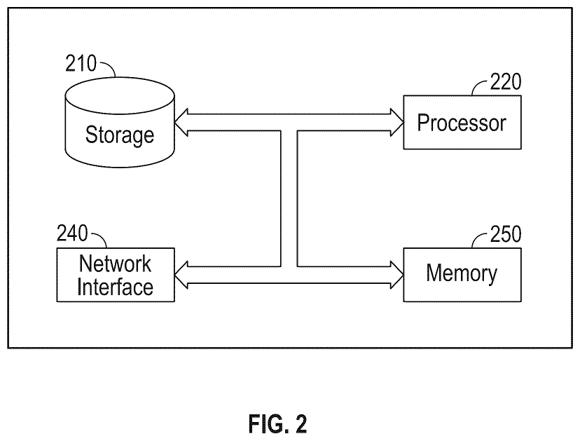

Referring now to FIG. 2, there is shown a block diagram of example components of any of the systems, devices, and/or servers of FIG. 1 in accordance with aspects of the present disclosure. The components include an electronic storage 210, a processor 220, a memory 250, and a network interface 240, among other components that persons skilled in the art will recognize. The various components may be communicatively coupled with each other. The processor 220 may be and may include any type of processor, such as a single-core central processing unit (CPU), a multi-core CPU, a microprocessor, a microcontroller, a digital signal processor (DSP), a System-on-Chip (SoC), an application specific integrated circuit (ASIC), or any other type of processor. The memory 250 may be a volatile type of memory, e.g., RAM, or a non-volatile type of memory, e.g., NAND flash memory. The memory 250 includes processor-readable instructions that are executable by the processor 220 to cause the systems, devices, and/or servers to perform various operations, including those mentioned herein.

The electronic storage 210 may be and include any type of electronic storage used for storing data, such as hard disk drive, solid state drive, and/or optical disc, among other types of electronic storage. The electronic storage 210 stores processor-readable instructions for causing the systems, devices, and/or servers to perform operations and store data associated with such operations. The network interface 240 may implement wireless networking technologies and/or wired networking technologies.

The components shown in FIG. 2 are merely examples, and persons skilled in the art will understand that systems, devices, and/or servers include other components not illustrated and may include multiples of any of the illustrated components. Such and other embodiments are contemplated to be within the scope of the present disclosure.

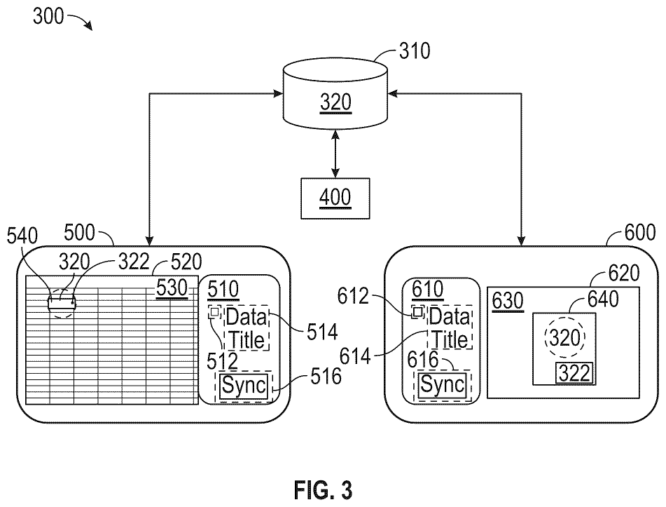

Referring now to FIG. 3, there is shown an illustration of a workflow 300 of system 100 in accordance with aspects of the present disclosure. The workflow 300 generally includes a central server 310, a web application, and an exemplary interface(s) used within documentation tools and/or programs, such as a data management application 500 and/or a presentation application 600. The workflow 300 is not limited to the described applications, tools, and/or programs, and any number of applications, tools, and/or programs are contemplated and within the scope of this disclosure.

The central server 340 is configured to store and/or manage a state of data 320 (e.g., individual data and/or dataset figures) using a global identifier 322, creating a centralized repository for data 320. The central server 340 may include and/or host a central database to store manage, and/or track versions of data 320. Data 320 may encompass any form of information (e.g., numerical, textual, graphical, and/or symbolic) which can be captured, stored, processed, and/or displayed, including a single element of data or a dataset. The central server 340 may communicate with various applications to handle data 320. For example, the central server 340 may manage and/or store data 320 pushed from the data management application 500 and/or data 320 created natively on the Internet, which may be used in a shape 640 in the presentation application 600. In another example, the central server 310 may display data 320 on the web application 400 to interact with the data 320 and/or workflow 300.

The central server 340 is configured to use end-to-end encryption and fine-grained user permissions to prevent unauthorized access of data 320. This provides a benefit over traditional centralized data management systems by securing data 320 at every stage of its lifecycle, from creation to storage and transmission. For example, unique encryption keys may be assigned to each user, ensuring access to specific data is controlled and logged. Moreover, central server 310 may use temporary session keys for real-time collaboration that are created and destroyed dynamically to reduce long-term exposure. In another example, central server 340 may use cryptographic hashes (e.g., SHA-256) to generate a checksum of the encrypted data, such that the checksum must be signed with a private key and verified at a recipient's end. In another example, role-based access controls (RBAC) may be employed by central server 310 to ensure only authorized users can decrypt and access specific shapes 640 and/or data 320 directly. In aspects, system 100 uses client-side encryption, encryption in transit, and/or encryption at rest.

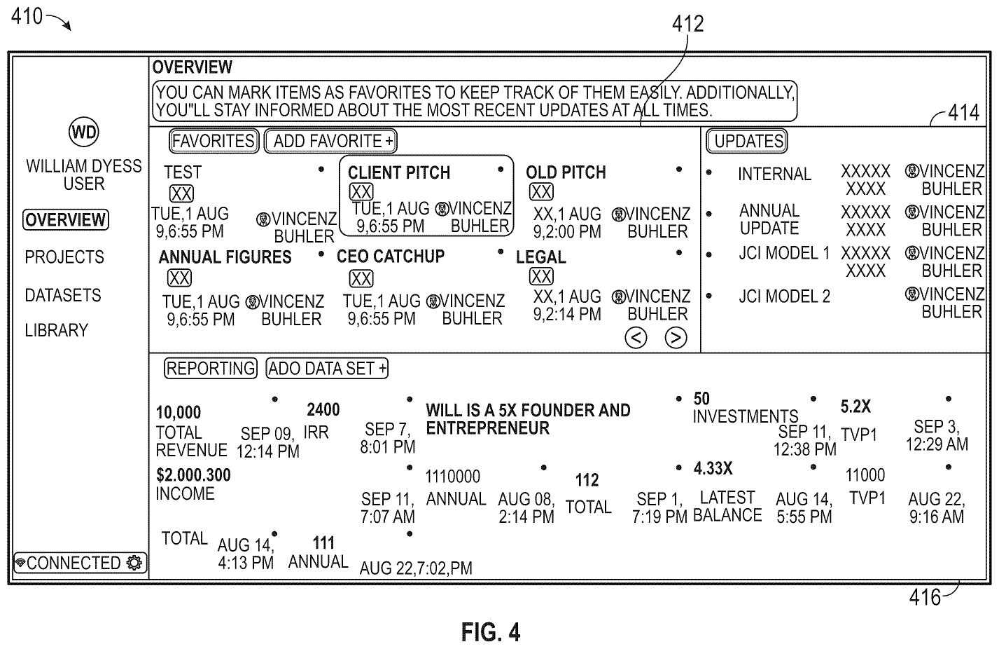

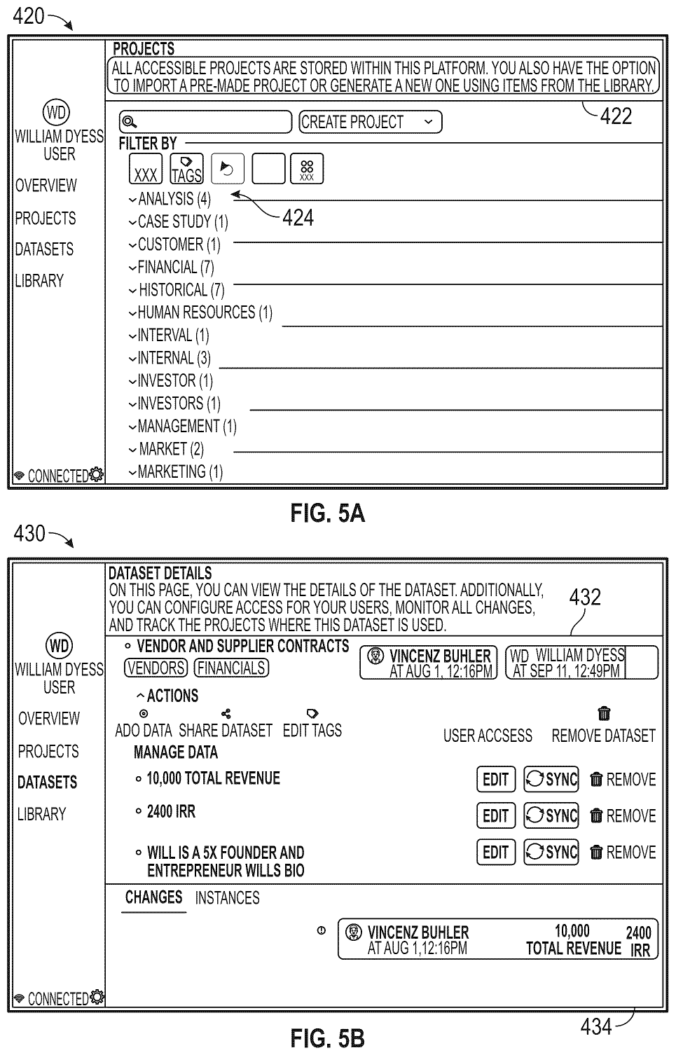

The web application 400 may enable a user to interact with data 320, view the status of data 320, and/or send instructions to other in-application environments, such as data management application 500 and/or presentation application 600. For example, the web application may include an overview of data 320 and/or other datasets used by the data management application 500 and/or presentation application 600 (e.g., a slide 630 or a shape 382 within a slide 630 in the presentation application 600) (FIG. 4). In another example, the web application 400 may enable a user to create projects based on data 320 (FIG. 5A). In another example, the web application 400 may enable a user to view, update, and/or manage data 320 based on a particular cell 540 in the data management application 500 and/or a particular shape 640 in the presentation application 360 (FIG. 5B).

Referring now to FIG. 4, an overview interface 410 is shown. The overview interface 410 generally includes a favorites frame 412, an updates frame 414, and a reporting frame 416. The favorites frame 412 enables a user to add, select, edit, and/or view favorite projects, datasets, and/or data 320. For example, the favorites frame 412 may display an add button and a variety of details on data 320, including an editable name, type, value, version, status indicator, prior update date, creation date, and/or owner. The updates frame 414 displays recent updates to data 320. For example, the updates frame 414 may include an update name, affected data 320, an update date, and a user who performed the update. The reporting frame 416 displays a reporting of various data 320, dates of reporting, and/or an option to add new data 320 for reporting. In aspects, selecting the data 320 on the favorites frame 412, the updates frame 414, and/or the reporting frame 416 may navigate the user to an interface with additional details about the data 320, such as a data details interface (FIG. 5B). In aspects, the overview interface 410 may be customizable via settings. For example, a user may be able to amend settings to add, remove, and/or rearrange the frames displayed based on user needs.

Referring now to FIG. 5A, a projects interface 420 is shown. The overview interface 410 generally includes a project frame 422, which displays individual projects 424. As used herein, a project 424 may include a single piece of data 320 and/or a set of related data 320, (e.g., a group of managed collections of data 320), such as sets of data 320 linked to slides 630, which may be incorporated into projects 424 for production documents. For example, a project 424 may include all data 320 used within a slide 630 and/or a presentation file 620. In another example, a project 424 may include all data 320 related to a set of investors, which may be used in multiple files and/or applications at once (e.g., in multiple slides 630 in various presentation files 620). A user may search and/or filter for different projects 424 within the project frame 422. For example, a user may select an alphanumerical order and/or filter results by various tags, which may be added to each project 424 for grouping, searching, and/or future reference. For each result line (e.g., each project 424), the user may select a dropdown arrow, which may be toggled to expand the result line to display additional information related to the data 320 and/or collapse the result line after viewing. In aspects, a user can toggle how projects 424 are viewed (e.g., list and/or grid view). A user may add new projects 424 via a “create project” button, including a title, data 320 included, user permissions, and/or tags.

Referring now to FIG. 5B, a data details interface 430 is shown. The data details interface 430 generally includes a details frame 432 and a sub-details frame 434. In the details frame 432, a user may review additional information related to specific data 320. For example, the details frame 432 may display an editable name, type, value, version, status indicator, prior update date, creation date, and/or owner. In addition, the details frame 432 may enable a user to take various actions related to data 230, such as adding new details related to data 320 and/or adding new data 320 to a dataset (e.g., an “add data” button), sharing data 320 with various applications (e.g., a “share data” button), revising tags associated with data 320 (e.g., an “edit tags” button), updated user permission for data 320 (e.g., a “user access” button), and/or deleting details related to data and/or data 320 (e.g., a “delete data” button). The details frame 432 may enable a user to easily manage various details of data 320. For example, a user may navigate to a specific line of data 320 (e.g., “Total Revenue”) and select an “edit” button to change a value, a “sync” button to update the value to the latest version, and/or a “delete” button to remove the value. The sub-details frame 434 includes additional, drilled-down details related to data 320, including different panels which a user may toggle between. For example, the sub-details frame 434 may display a log of changes to data 320, such as when values were added, removed, and/or updated. In another example, the sub-details frame 434 may display specific instances of data 320 (e.g., which files, projects, etc. that data 320 is currently being used in).

In aspects, sub-details frame 434 may include a log of changes by displaying a visual diff tool that may allow users to compare versions of data 320, shapes 640, slides 630, or entire presentation files 620. For example, in relation to data, the tool may lay out each change in value, formula and/or formatting. In another example, in relation to a shape 640, the tool may highlight, label, and/or explain differences in text, formatting, and/or layout directly on a visual of the slide 630. The sub-details frame 434 may allow users to navigate a timeline of changes and/or preview previous versions without overwriting the current state of a file, merge changes from multiple collaborators, and/or even reconcile conflicts in overlapping edits through fine-grained snapshots recording individual changes as separate entities. To assist with such snapshots, the central server 310 may communicate metadata such as timestamps, identifiers, version numbers, and/or instance relationships to facilitate auditing and rollback functionality. This provides a benefit over traditional auditing tools by providing fine-grained histories using immutable shape identifiers and cross-application integration, which enable asynchronous updates between applications.

The web application 400 is not limited to the interfaces and/or frames shown, and any number of interfaces, frames, and/or additional functionality are contemplated and within the scope of this disclosure. For example, web application 400 may include a library interface with various types of data 320 capable of central management (e.g., a combined dataset), which may be imported into a presentation 380, such as data 320 linked to shapes 640, slides 630, cells 540, spreadsheets 530, files, and/or projects 424 with preset templates and/or details. In doing so, the library may enable tracking and/or managing of individual details linked to data 320, such as slides 630, as primitives within a dataset (e.g., a marketing stack). For example, a user can reuse a template of a slide 630 with the desired shapes 640 linked to data 320, avoiding the time spent on manual generation. In aspects, web application 400 may include a settings interface to manage various settings related to the display, user settings, and/or data 320.

The data management application 500 (e.g., a spreadsheet application) may be used for managing data 320 within the workflow 300. While described as an application for spreadsheets, the data management application 500 may be any type of data management medium (e.g., a grid-based data management system or structured information tool). The data management application 500 may manage content within a spreadsheet file 520 (e.g., a workbook) containing individual spreadsheets 530 (e.g., worksheets). The data 320 may typically represent information in a cell 540 within a spreadsheet 530 and/or instance of individual data 320, which may be housed within the data management application 500. For example, data 320 may include numbers, text, formulas, computed results, and/or associated metadata within a cell 540. In aspects, data 320 may encompass an entire spreadsheet 530 and/or spreadsheet file 520.

Each cell 540 may include a global identifier 322 used by central server 310 to retrieve and/or communicate data 320. In aspects, global identifier 322 may be a universally unique identifier or UUID written in hexadecimal format, a shape ID, a form of unique identifier, and/or an underlying data figure. The data 320 may be traceable to the cell 540 and/or the data management application 500 generally using the global identifier 322 with any techniques known to one skilled in the art, such as mapping tables, metadata, and/or event-driven mechanisms. For example, central server 310 may maintain a mapping table and/or database that associates each global identifier 322 with a specific cell 540 and/or the data management application 500 and corresponding location, size, and/or dimension within the application where data 320 is used.

A plug-in 510 may run within the environment of the data management application 500. Generally, the plug-in 510 includes a status indicator 512, a data title 514, and/or a synchronization button 516. The plug-in 510 is configured to extend features of the data management application 500 for use with additional applications, such as the central server 310, the web application 400, and/or a presentation application 600. For example, the plug-in 510 may be used export data 320 from a cell 540 to central server 310, so that data 320 may be used in other applications. In another example, the plug-in 510 may be used to import data 320 from central server 340 into a spreadsheet file 520, such as data 320 to be housed within an individual cell 540. The plug-in 510 may run locally, with external communication(s), and/or run as a web-based plug-in. In aspects, the plug-in 510 may include a proprietary API.

The status indicator 512 may be a dynamic, color-coded module, which indicates the synchronization status of data 320. For example, the status indicator 512 may be green when data 320 is synchronized to the latest version and red when data 320 is out-of-synchronization with the latest version. In aspects, other colors may be used to denote alternative statuses of data 320 (e.g., no match, data error, etc.). The data title 514 indicates a name and/or designation for data 320. The data title 514 may be user-generated, randomly generated, and/or generated using predictive technology. For example, the title may be provided by a machine learning algorithm based on the content and/or type of data 320. In aspects, the data title 514 may be automatically synchronized between different instances and/or applications, or manually updated by a user. The text of data title 514 many include any combination of alphanumeric characters. The synchronization button 516 may be used to synchronize data 320 to the latest, centralized version (e.g., a version retained at central server 310). In aspects, a synchronization action of synchronization button 330c may be triggered automatically upon each update and/or during scheduled intervals. In aspects, the synchronization button 516 may be restricted based on user permissions.

A presentation application 600 (e.g., a canvas-based design medium) may also be used for managing data 320 within the workflow 300. While described as an application for slide presentations, the presentation application 600 may be any type of design application and/or canvas-based design medium (e.g., digital content creation platform or graphical authoring composition tool). Generally, presentation application 600 enables the storage, presentation, and/or communication of instructions directed from the web server 340, which may be used to manage and/or report the state of data 320. For example, presentation application 600 may manage numerical, textual, and/or pictorial content in a presentation file 620 containing slides 630.

The data 320 may typically represent information in a shape 640 within a slide 630. Generally, a shape 640 is a graphical object or element including a defined data type and source. The shape 640 may be an immutable shape whose properties (e.g., text or numerical values within) cannot be altered within the context of the presentation application 600 and/or have limited properties (e.g., design such as size and shape) that may be altered within presentation application 600. In aspects, data 320 may encompass an entire slide 630 and/or presentation file 620. In addition to the values in data 320 based on cell 540 (e.g., numbers, text, formulas, computed results, and/or associated metadata), data 320 may include information specific to a shape 640, such as additional numerical, textual, and/or graphical parameters (e.g., xy coordinates related to shape, size, and/or position in a slide 630). To individually manage portions of data 320, system 100 is configured to atomize portions of shape 640, slides 630, and/or entire presentation files 620 within presentation application 600. For example, defined coordinates (e.g., height, width) on a defined canvas are saved with a specific taxonomy. In aspects, system 100 is configured to save components, which are groups of shapes 640 (e.g., datasets of datasets).

Each shape 640 may include the global identifier 322 used by central server 310 to communicate the data 320 with presentation application 600 to update the shape 640. In aspects, a native shape identifier of shape 640 generated by the presentation application 600 may be replaced with global identifier 322. In aspects, the global identifier 322 may enable the shape 640 to be immutable. The data 320 may be traceable to the shape 640 and/or presentation application 600 generally using the global identifier 322 with any techniques known to one skilled in the art, such as mapping tables, metadata, and/or event-driven mechanisms. For example, central server 310 may maintain a mapping table and/or database that associates each global identifier 322 with a specific shape 640 and/or the presentation application 600 and corresponding location, size, and/or dimension within the application where data 320 is used.

A plug-in 610 may be configured to execute operations within the workflow 300, such as updates within the presentation application 600. Generally, the plug-in 610 includes a status indicator 612, a data title 614, and/or a synchronization button 616. The plug-in 610 is configured to extend features of the spreadsheet application 600 for use with additional applications, such as the central server 310, the web application 400, and/or a data management application 500. For example, the plug-in 610 may be used import a shape 640 containing data 320 via central server 310. In another example, the plug-in 610 may be used to export a shape 640, such as an updated shape containing data 320, to the central server 310. The plug-in 610 may run locally, with external communication(s), and/or run as a web-based plug-in. In aspects, the plug-in 610 may include a proprietary API. The plug-in 610 includes functionality similar to the plug-in 510.

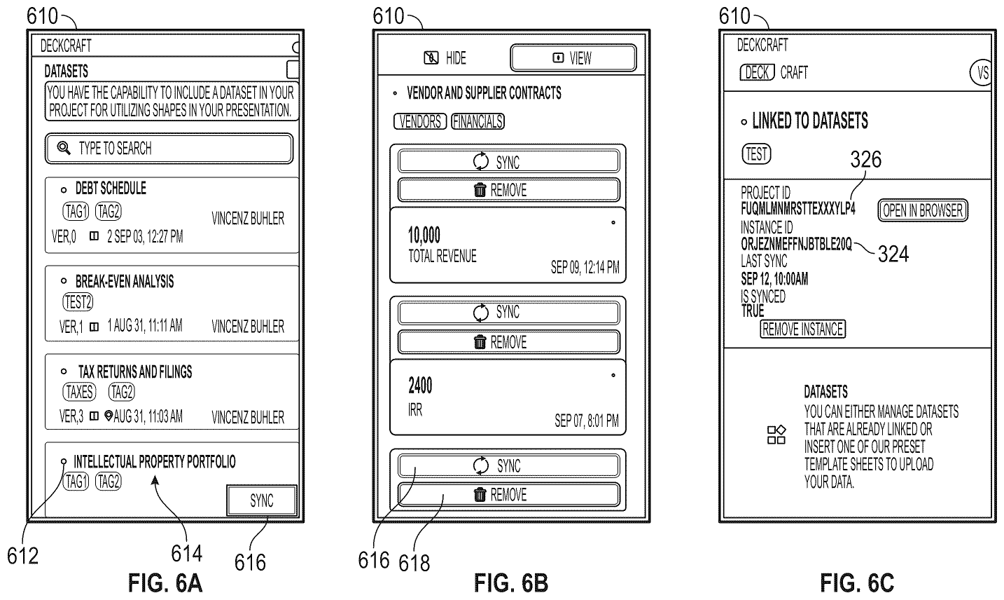

Now referring to FIGS. 6A-6C, various features of the plug-in 610 within the presentation application 600 are shown. FIG. 6A shows a data details view of plug-in 610. The data details view typically shows a list of data 320, which a user may import into spreadsheet application 600. Generally, the data details view includes the status indicator 612, the data title 614, and the synchronization button 616. The data details view of plug-in 610 may be similar in aspects to data details interface 430. For example, data details view of plug-in 610 may display an editable name, type, value, version, status indicator, prior update date, creation date, and/or owner. FIG. 6B shows a projects view of plug-in 610. The projects view typically shows details of a project 424, with options to manage data 320. For example, a user may synchronize data 320 to a particular version with the synchronization button 616 and/or delete data 320 with the deletion button 618. The projects view may be similar in aspects to the projects interface 420. For example, the projects view may include all data 320 used within a slide 630 and/or a presentation file 620 and/or a user may search and/or filter for different projects 424.

FIG. 6C shows an instance view of plug-in 610. The instance view displays details specific to an instance of data 320, such as an instance identifier 324 (e.g., an “instance ID” or a unique identifier) and/or a project identifier 326. The instance identifier 324 is a unique identifier similar to global identifier 322, which is generally recognized by all components of system 100 and used for communication related to data 320. In doing so, the components of system 100 (e.g., plug-in 610) may determine whether data 320 matches a centrally stored version of data 320 on the central server 310, e.g., enabling version control methods. Thus, in aspects, the plug-in 610 may use the instance identifier 324 to manage, use, and/or view an instance of data 320. In aspects, the instance identifier 324 may be a universally unique identifier or UUID written in hexadecimal format, a shape ID, a form of unique identifier, and/or an underlying data figure. The project identifier 326 may operate in a manner similar to the instance identifier 324.

Updates communicated by plug-in 610 are typically related to a shape 640 and/or a slide 630, such as updating a visual configuration of a shape 640 (e.g., xy coordinates, color, size, etc. using global identifier 322 as a shape identifier) and/or updating a value of data 320 within shape 640 based on an update elsewhere in system 100, such as at data management application 500 (e.g., updating a value of 1.3 million to 1.4 million). Plug-in 610 may communicate the global identifier 322 to the central server 310 to retrieve a shape 640 configuration and/or the contents of the shape 640 for data management and/or version control purposes, such as to determine a synchronization state of data 320 within shape 382. In another example, plug-in 610 may communicate the global identifier 322 to the central server 310 to import data 320 into a shape 640 and/or slide 630 of a presentation file 620. Using the global identifier 322, the plug-in 610 may cause the workflow 300 to execute instructions sent from web application 400 and/or another client-side application (e.g., global updates of data 320). For example, the plug-in 610 may detect a change of a shape 640 based on altered coordinates, font sizes, colors, and/or shape. In doing so, the plug-in 610 may replace data 320 in shape 640 with updated information from the central server 310, which relates to a particular version. In aspects, the plug-in 610 may alter file characteristics, which are unique to the instance and/or project 242 containing data 320 and/or another dataset within workflow 300.

Updates communicated by plug-in 510 are generally related to data 320 within a cell 540 (e.g., using global identifier 322 as a data instance identifier). For example, plug-in 510 may communicate the global identifier 322 to the central server 310 to update a value of data 320. The plug-in 510 of data management application 500 may also cause the workflow 300 to execute instructions sent from web application 400 and/or another client-side application. Generally, the plug-in 510 operates in a similar manner to plug-in 610 using data identifier 522 and/or project identifier 326. For example, the plug-in 510 may detect a change in a cell 540 based on an altered value, such as an update in revenue from 1.3 million to 1.4 million. In doing so, the plug-in 510 may upload data 320 in cell 540 to central server 310 to provide updated information, which relates to a particular version. Then, plug-in 610 may recognize the update to data 320 and update the value of data 320 within a linked shape 640 in a slide 630.

Both plug-in 510 and plug-in 610 may be implemented for cross-platform integration to support a variety of applications within a centralized server (e.g., central server 310), such as various data management mediums and canvas-based design mediums. For example, plug-ins 510, 610 may be integrated with proprietary APIs having a modular and flexible architecture (e.g., client-side, middleware, and/or server-side) to support robust, cross-platform functionality. During operation, plug-ins 510, 610 may listen for and/or fetch updates in real-time linked to data 320 and/or shapes 640, while validating data integrity. For example, server-side architecture may store shape 640 metadata, immutable identifiers (e.g., global identifier 232), version history, and/or relationships to cells 540, while pushing updates to connected clients (e.g., data management application 500 and presentation application 600) in real-time. In aspects, plug-ins 510, 610 may provide extended support for alternative tools, including applications not listed herein such as word processors, image editors, programming software, and/or web-based tools.

In aspects, plug-ins 510, 610 may be configured to track individual events occurring within data management application 500 and presentation application 600, such as updates to a cell 540 or a shape 640. For example, plug-ins 510, 610 may render a domain-specific language (DSL) configured to enable functionality within system 100. The plug-ins 510, 610 may act as interpreters or middleware that process DSL scripts and/or rules to monitor, log, and manage updates. For example, plug-in 610 may implement event listeners to track changes in a shape property (e.g., text, size, and/or position), which trigger the evaluation of corresponding rules and metadata tagging (e.g., event source, timestamp, global identifier) for tracking and auditing. After evaluating the rules, plug-in 610 may push and/or pull updates, for example, sending changes for data 320 to central server 310 and/or querying the central server 310 for updated values of data 320 to apply to the linked shape 640. Events may be stored at central server 310 and/or exported into a report for analysis. For example, web application 400 may be used to select a user and date range and export a full report including a list of versions, dates, times, and/or xy coordinates in each event. In aspects, system 100 may be configured to provide real-time notifications regarding specific events, such as in-app, banners, badges, SMS, and/or text notifications.

System 100 may use artificial intelligence (AI) and/or machine learning (ML) to enhance features of centralized data management by improving automation, accuracy, efficiency, and user experience. In aspects, natural language processing (NLP) may be used to automate data 320 recognition and association by suggesting links automatically. For example, NLP may analyze the contents of a cell 540 (e.g., “Sales Q1”) and suggest linking the data 320 in cell 540 to a shape 640 in a slide 630 labeled “Q1 Sales Chart.” In aspects, NLP may enhance version control by automating tracking and management of changes. For example, NLP may summarize updates for logs in sub-details frame 434. ML models may also compare changes across different versions of data 320 and provide intelligent suggestions to resolve conflicts, such as merging edits and/or prioritizing changes based on historical patterns. In aspects, AI may provide predictive updates and adaptive workflows. For example, ML models may predict trends in data 320, suggest insights to incorporate in a slide 630, and/or predict which slide 630 a shape 640 relates to based on data 320 using tags, metadata, and/or other contextual details. In another example, a neural network may automative repetitive tasks, such as applying consistent styles, updating linked shapes, and/or new slide generation (e.g., auto-generate slide 630 contents). In another example, a neural network may highlight differences between user versions and offer suggestions for merging changes.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

It will be understood that, while spreadsheet and presentation documents are referenced, various other applications may be compatible with workflow 300, including word processors, image editors, and web-based applications.

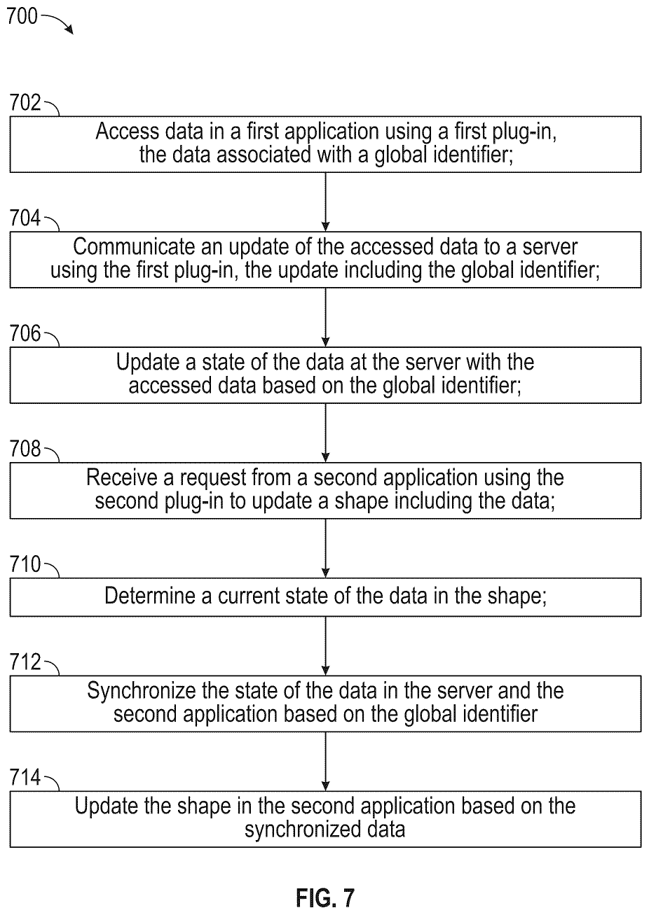

FIG. 7 shows a method 700 for an exemplary use of the system 100. Although the steps of method 700 of FIG. 7 are shown in a particular order, the steps need not all be performed in the specified order, and certain steps can be performed in another order. For example, FIG. 7 will be described below with a server (e.g., central server 310 of FIG. 3 and/or controller 200 of FIG. 2) performing the operations. In other aspects, the method 700 of FIG. 7 may be performed all or in part by another device, for example, a mobile device and/or a client computer system. These and other variations are contemplated to be within the scope of the present disclosure.

Initially, at step 702, the controller 200 causes the system 100 to access data 320 in a data management application 500 (e.g., a first application) using a first plug-in 510. Generally, the data 320 is associated with a global identifier 322. For example, a server may access an alphanumerical value in a cell of a spreadsheet application based on linkage to a global identifier stored in a mapping table of a database, which may be hosted by the server.

Next, at step 704, the controller 200 causes the system 100 to communicate an update of the accessed data 320 to the central server 310 using the first plug-in 510. Generally, the update sent to the central server 310 includes the global identifier 322. For example, a user may enter an updated value in a cell of a spreadsheet application, which triggers a first plug-in to communicate the update to a server.

Next, at step 706, the controller 200 causes the system 100 to update a state of the data 320 at the central server 310 with the accessed data 320 based on the global identifier 322. For example, a server may then update a state (e.g., a version) of linked data using a mapping table via the global identifier. Typically, updating the state of the data 320 at the central server 310 triggers an event listener in the second plug-in 610 housed in the presentation application 600 (e.g., a second application). For example, an event listener may send a request using a domain-specific language (DSL) to gather data.

Next, at step 708, the controller 200 causes the system 100 to receive a request from the presentation application 600 using the second plug-in 610 to update a shape 640 including the data 320. For example, the request may include updating a numerical value in a slide of a presentation with a newer value from a first version to a second version.

Next, at step 710, the controller 200 causes the system 100 determine a current state of the data 320 in the shape 640. The first plug-in 510 and the second plug-in 610 are generally configured to render a domain-specific language for communicating with the central server 310 to synchronize the data 320, such that determining the current state of the data 320 in the shape 640 includes determining a latest version of the data 320 stored in a database hosted by the central server 310, e.g., the second plug-in 610 and/or the central server 310 may detect that the data 320 at the presentation application 600 is a first version different from that at the central server 310 and communicate same. For example, a server can use a mapping table to determine that a presentation application is using version 1.0, whereas the server has a newer version 2.0 of the same data, which it can send to the application. In aspects, the first plug-in 510 and the second plug-in 610 are configured to track individual events related to changes to the data 320 within the data management application 510 and the presentation application 600 respectively, such that tracked individual events are accessible on the web application 400 and/or or a report exported by the web application 400.

Next, at step 712, the controller 200 causes the system 100 to synchronize the state of the data 320 in the central server 310 and the presentation application 600 based on the global identifier 322. For example, a server may send version 2.0 to a presentation application through a second plug-in.

Next, at step 714, the controller 200 causes the system 100 update the shape in the second application based on the synchronized data. For example, updating a shape may include updating an alphanumerical value, a shape, a size, a color, and/or coordinates of the shape in a fixed canvas.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms, or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages that are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above are also intended to be within the scope of the disclosure.

What is claimed is:

1. A system for centralized data management, comprising:
a processor; and
a memory including instructions, which when executed by the processor, cause the system to:
access data in a first application using a first plug-in, the data associated with a global identifier;
communicate an update of the accessed data to a server using the first plug-in, the update including the global identifier;
update a state of the data at the server with the accessed data based on the global identifier, wherein updating the state of the data at the server triggers an event listener in a second plug-in;
receive a request from a second application using the second plug-in to update a shape including the data;
determine a current state of the data in the shape;
synchronize the state of the data in the server and the second application based on the global identifier; and
update the shape in the second application based on the synchronized data.

2. The system of claim 1, wherein the first application is a data management application.

3. The system of claim 1, wherein the second application is a canvas-based design medium.

4. The system of claim 3, wherein the shape is located in a slide of the canvas-based design medium.

5. The system of claim 3, wherein in the shape is at least one of a text box, an image, a video, a table, a geometric shape, or a freeform shape.

6. The system of claim 3, wherein updating the shape includes updating at least one of an alphanumerical value, a shape, a size, a color, or coordinates of the shape in a fixed canvas.

7. The system of claim 1, wherein the shape is immutable within the second application.

8. The system of claim 7, wherein multiple shapes are configured to be grouped together as an immutable component.

9. The system of claim 1, wherein the first plug-in and the second plug-in are configured to render a domain-specific language for communicating with the server to synchronize the data, and wherein determining the current state of the data in the shape includes determining a latest version of the data stored in a database hosted by the server.

10. The system of claim 1, wherein the first plug-in and the second plug-in are configured to track individual events related to changes to the data within the first application and the second application respectively, and wherein the tracked individual events are accessible on at least one of a web application or a report exported by the web application.

11. A method for centralized data management, comprising:
accessing data in a first application using a first plug-in, the data associated with a global identifier;
communicating an update of the accessed data to a server using the first plug-in, the update including the global identifier;
updating a state of the data at the server with the accessed data based on the global identifier, wherein updating the state of the data at the server triggers an event listener in a second plug-in;
receiving a request from a second application using the second plug-in to update a shape including the data;
determining a current state of the data in the shape;
synchronizing the state of the data in the server and the second application based on the global identifier; and
updating the shape in the second application based on the synchronized data.

12. The method of claim 11, wherein the first application is a data management application.

13. The method of claim 11, wherein the second application is a canvas-based design medium.

14. The method of claim 13, wherein the shape is located in a slide of the canvas-based design medium.

15. The method of claim 13, wherein in the shape is at least one of a text box, an image, a video, a table, a geometric shape, or a freeform shape.

16. The method of claim 13, wherein updating the shape includes updating at least one of an alphanumerical value, a shape, a size, a color, or coordinates of the shape in a fixed canvas.

17. The method of claim 11, wherein the shape is immutable within the second application.

18. The method of claim 17, wherein multiple shapes are configured to be grouped together as an immutable component.

19. The method of claim 11, wherein the first plug-in and the second plug-in are configured to render a domain-specific language for communicating with the server to synchronize the data, and wherein determining the current state of the data in the shape includes determining a latest version of the data stored in a database hosted by the server.

20. A non-transitory computer readable storage medium including instructions that, when executed by a computer, cause the computer to perform a method for centralized data management, the method comprising:
accessing data in a first application using a first plug-in, the data associated with a global identifier;
communicating an update of the accessed data to a server using the first plug-in, the update including the global identifier;
updating a state of the data at the server with the accessed data based on the global identifier, wherein updating the state of the data at the server triggers an event listener in a second plug-in;
receiving a request from a second application using the second plug-in to update a shape including the data;
determining a current state of the data in the shape;
synchronizing the state of the data in the server and the second application based on the global identifier; and
updating the shape in the second application based on the synchronized data.
